(19) United States
(12) Patent Application Publication
(10) Pub. No.: US 2026/0016844 A1
(43) Pub. Date: Jan. 15, 2026

(54) METHOD AND APPARATUS FOR INTELLIGENT CONTROL OF GAS DEVICE

(71) Applicant: Chant Heat Energy Science & Technology (Zhongshan) Co., Ltd., Zhongshan (CN)

(72) Inventors: Guangzhi Mai, Zhongshan (CN); Guoquan Chen, Zhongshan (CN); Jiaquan Deng, Zhongshan (CN); Xianmin Deng, Zhongshan (CN)

(21) Appl. No.: 18/946,986

(22) Filed: Nov. 14, 2024

(30) Foreign Application Priority Data
Jul. 10, 2024 (CN) 202410926332.6

(51) Int. Cl. G05D 23/19

(52) U.S. Cl. CPC G05D 23/1917

(57) ABSTRACT

Disclosed is a method and an apparatus for intelligent control of a gas device. The method includes: performing an operation pre-process on a gas device to obtain an operation pre-process result corresponding to the gas device after confirming the gas device is powered on, in which the operation pre-process includes device self-testing and control link establishment; performing a temperature measurement to obtain temperature data of a target environment where the gas device is located when the operation pre-process result indicates that the gas device meets preset operating conditions; generating gas control instructions for the gas device according to the temperature data and using requirements for the gas device; and performing an operation adjustment on the gas device according to the gas control instructions, in which the operation adjustment includes at least one of gas flow adjustment, output power adjustment, and gas device on/off control.

### CROSS-REFERENCE TO RELATED APPLICATIONS

The present disclosure claims the priority of Chinese Patent Application No. 2024109263326 filed on Jul. 10, 2024 before CNIPA. All the above are hereby incorporated by reference in their entirety.

### TECHNICAL FIELD

The present disclosure relates to the technical field of intelligent control of appliances and, particularly, to a method and an apparatus for intelligent control of gas appliances.

### BACKGROUND

With the continuous improvement of energy utilization technology, gas has been widely used as an efficient and clean energy source. For safe use of gas, gas devices are designed to safely control the output and use of gas. However, most gas devices in the prior art generally have traditional mechanical controls, i.e., the user needs to control the gas device on site by pressing buttons. Such a control method relies on the subjective perception of the user. Improper use of the gas device may pose a greater safety risk, if the user is not clear about how to use the gas device and does not know how to adjust the operating parameters of the gas device. Evidently, it is particularly important to provide a corresponding solution addressing the situation where users of gas devices may face inaccurate device control and potential safety risks.

### SUMMARY

Provided in the present disclosure is a method and apparatus for intelligent control of a gas device, which can improve the user's control accuracy of gas devices, improve the safety of using gas devices, and adapt to the user's gas usage needs.

In order to address the aforementioned technical problems, disclosed as a first aspect in the present disclosure is a method for intelligent control of a gas device, including:
performing an operation pre-process on a gas device to obtain an operation pre-process result corresponding to the gas device after confirming the gas device is powered on, in which the operation pre-process includes device self-testing and control link establishment;
performing a temperature measurement to obtain temperature data of a target environment where the gas device is located when the operation pre-process result indicates that the gas device meets preset operating conditions;
generating, according to the temperature data and using requirements for the gas device, control instructions for the gas device; and
   performing, according to the control instructions, an operation adjustment on the gas device, in which the operation adjustment includes at least one of gas flow adjustment, output power adjustment, and gas device on/off control.

As an optional implementation, in the first aspect of the present disclosure, before generating control instructions for the gas device according to the temperature data and using requirements for the gas device, the method further includes:
identifying the instruction trigger type corresponding to the control instructions when the control instructions for the gas device are detected, the instruction trigger type including a real-time trigger type or a non-real-time trigger type; generating the control instructions when one of preset conditions is met if the instruction trigger type is the non-real-time trigger type; and
identifying, according to the instruction trigger type, a control specification corresponding to the control instructions, the control specification including at least device adjustment requirements of the gas device to serve as usage requirements of the gas device,
in which the control specification includes at least an operating duration control specification of the gas device and an output power adjustment specification corresponding thereto.

As an optional implementation, in the first aspect of the present disclosure, the identifying, according to the instruction trigger type, the control specification corresponding to the control instructions includes:
identifying, from a gas control program corresponding to the gas devices, an adaptation response program corresponding to the control instructions and an adaptation program function corresponding to the control instructions to serve as the control specification corresponding to the control instructions when the instruction trigger type is the real-time trigger type;
obtaining device historical use data of the gas device if the instruction trigger type is the non-real-time trigger type;
   identifying, from the device historical use data, target use data matching current use conditions; and

identifying, from the target use data, operation data corresponding to historical post-operation of the current use conditions to serve as the control specification corresponding to the control instructions, the operation data being operation log data of the gas device.

As an optional implementation, in the first aspect of the present disclosure, the identifying, from the device historical use data, target use data matching current use conditions includes:
identifying time information and device operation information corresponding to the gas device currently in use, in which the time information includes at least start-up time of the gas device, and the device operation information include at least current operation parameters of the gas device;
performing a data match on the device historical use data using the time information, the device operation information, and the temperature data as basis parameters to obtain a data match result, the data match result including at least one piece of the device historical use data to be filtered and being marked as candidate data, in which a matching priority of the device operation information and the temperature data is higher than that of the time information;
determining whether target candidate data are present in all the candidate data; and
   identifying the target candidate data as the target use data matching the current use conditions when it is determined that the target candidate data are present in all the candidate data, in which a data matching value of the target candidate data is higher than a preset matching threshold value.
each piece of the candidate data includes a first matching value corresponding to the time information, a second matching value corresponding to the device operation information, and a third matching value corresponding to the temperature information;
the identifying, from the device historical use data, target use data matching current use conditions further includes:
identifying, from all the candidate data, secondary preferred data when it is determined, from all the candidate data, that none of the target candidate data is higher than the preset matching threshold value, in which the secondary preferred data are data among all the candidate data meet at least one of following conditions: the first match value corresponding to the candidate data is a highest one, the second match value corresponding to the candidate data is a highest one, and the third match value corresponding to the candidate data is a highest one, and an amount of the secondary preferred data is within a preset number range; and
performing a parameter integration of all the secondary preferred data using the time information, the device operation information, and the temperature data as integration terms, to obtain parameter integration data to serve as the target use data matching the current use conditions.

As an optional implementation, in the first aspect of the present disclosure, the generating control instructions for the gas device according to the temperature data and using requirements for the gas device includes:
comparing the temperature data and a reference temperature range to obtain a comparison result between the temperature data and the reference temperature range, in which the comparison result includes: a first comparison result indicating the temperature data are higher than the reference temperature range, a second comparison result indicating the temperature data are lower than the reference temperature range, or a third comparison result indicating the temperature data are within the reference temperature range; and
generating gas control instructions for the gas device in combination with current device operation parameters of the gas device, using the control specification and the device adjustment requirements included therein as a baseline item, and the comparison result as a corrected reference item.

As an optional implementation, in the first aspect of the present disclosure, the performing, according to the control instructions, the operation adjustment on the gas device includes:
identifying instruction execution items corresponding to the control instructions;
traversing a target operation program matching the instruction execution items among the operation programs configured in the gas device;
identifying, according to the instruction execution items, program execution parameters of the target operation program, in which the program execution parameters include at least one parameter of: a first parameter configured to perform gas flow adjustment, a second parameter configured to perform output power adjustment, and a third parameter configured to perform gas device on/off control; and
performing, according to the target operation program and the program execution parameters corresponding thereto, the operation adjustment on the gas device.

Disclosed as a second aspect in the present disclosure is an apparatus for intelligent control of a gas device, including:
an operation pre-processing module, configured to perform an operation pre-process on a gas device to obtain an operation pre-process result corresponding to the gas device after confirming the gas device is powered on, in which the operation pre-process includes device self-testing and control link establishment;
a temperature measuring module, configured to perform a temperature measurement to obtain temperature data of a target environment where the gas device is located when the operation pre-process result indicates that the gas device meets preset operating conditions;
an instruction generating module, configured to generate, according to the temperature data and using requirements for the gas device, control instructions for the gas device; and
an operation adjusting module, configured to perform, according to the control instructions, an operation adjustment on the gas device, in which the operation adjustment includes at least one of gas flow adjustment, output power adjustment, and gas device on/off control.

As an optional implementation, in the second aspect of the present disclosure, the apparatus further includes:
a detecting module, configured to detect the control instructions for the gas device before the instruction generating module generates, according to the temperature data and using requirements for the gas device, control instructions for the gas device;
an identifying module, configured to identify the instruction trigger type corresponding to the control instructions, the instruction trigger type including a real-time trigger type or a non-real-time trigger type; generating the control instructions when one of preset conditions is met if the instruction trigger type is the non-real-time trigger type; and
the identifying module, further configured to identify, according to the instruction trigger type, a control specification corresponding to the control instructions, the control specification including at least device adjustment requirements of the gas device to serve as usage requirements of the gas device,
in which the control specification includes at least an operating duration control specification of the gas device and an output power adjustment specification corresponding thereto.

As an optional implementation, in the second aspect of the present disclosure, the way of the identifying module identifying, according to the instruction trigger type, the control specification corresponding to the control instructions specifically includes:
identifying, from a gas control program corresponding to the gas devices, an adaptation response program corresponding to the control instructions and an adaptation program function corresponding to the control instructions to serve as the control specification corresponding to the control instructions if the instruction trigger type is the real-time trigger type;
obtaining device historical use data of the gas device if the instruction trigger type is the non-real-time trigger type;
   identifying, from the device historical use data, target use data matching current use conditions; and
identifying, from the target use data, operation data corresponding to historical post-operation of the current use conditions to serve as the control specification corresponding to the control instructions, the operation data being operation log data of the gas device.

As an optional implementation, in the second aspect of the present disclosure, the way of the identifying module identifying, from the device historical use data, target use data matching current use conditions specifically includes:
identifying time information and device operation information corresponding to the gas device currently in use, in which the time information includes at least start-up time of the gas device, and the device operation information include at least current operation parameters of the gas device;
performing a data match on the device historical use data using the time information, the device operation information, and the temperature data as basis parameters to obtain a data match result, the data match result including at least one piece of the device historical use data to be filtered and being marked as candidate data, in which a matching priority of the device operation information and the temperature data is higher than that of the time information;
determining whether target candidate data are present in all the candidate data; and
   identifying the target candidate data as the target use data matching the current use conditions when it is determined that the target candidate data are present in all the candidate data, in which a data matching value of the target candidate data is higher than a preset matching threshold value.

As an optional implementation, in the second aspect of the present disclosure, each piece of the candidate data includes a first matching value corresponding to the time information, a second matching value corresponding to the device operation information, and a third matching value corresponding to the temperature information.

The identifying module identifying, from the device historical use data, target use data matching current use conditions specifically further includes:
identifying, from all the candidate data, secondary preferred data when it is determined, from all the candidate data, that none of the target candidate data is higher than the preset matching threshold value, in which the secondary preferred data are data among all the candidate data meet at least one of following conditions: the first match value corresponding to the candidate data is a highest one, the second match value corresponding to the candidate data is a highest one, and the third match value corresponding to the candidate data is a highest one, and an amount of the secondary preferred data is within a preset number range; and
performing a parameter integration of all the secondary preferred data using the time information, the device operation information, and the temperature data as integration terms, to obtain parameter integration data to serve as the target use data matching the current use conditions.

As an optional implementation, in the second aspect of the present disclosure, the step of the instruction generating module generating, according to the temperature data and using requirements for the gas device, control instructions for the gas device specifically includes:
comparing the temperature data and a reference temperature range to obtain a comparison result between the temperature data and the reference temperature range, in which the comparison result includes: a first comparison result indicating the temperature data are higher than the reference temperature range, a second comparison result indicating the temperature data are lower than the reference temperature range, or a third comparison result indicating the temperature data are within the reference temperature range; and
generating gas control instructions for the gas device in combination with current device operation parameters of the gas device, using the control specification and the device adjustment requirements included therein as a baseline item, and the comparison result as a corrected reference item.

As an optional implementation, in the second aspect of the present disclosure, the step of the operation adjusting module performing, according to the control instructions, the operation adjustment on the gas device specifically includes:
identifying instruction execution items corresponding to the control instructions;
traversing a target operation program matching the instruction execution items among the operation programs configured in the gas device;
identifying, according to the instruction execution items, program execution parameters of the target operation program, in which the program execution parameters include at least one parameter of: a first parameter configured to perform gas flow adjustment, a second parameter configured to perform output power adjustment, and a third parameter configured to perform gas device on/off control; and
performing, according to the target operation program and the program execution parameters corresponding thereto, the operation adjustment on the gas device.

Disclosed as a third aspect in the present disclosure is another apparatus for intelligent control of a gas device, including:
a memory, memorized with an executable code; and
a processor, coupled with the memory,
in which the processor invokes the executable code memorized in the memory to perform the method for intelligent control of the gas device disclosed by the first aspect of the present disclosure.

Disclosed as a fourth aspect in the present disclosure is a non-transitory computer memory medium, and the non-transitory computer memory medium memorizes computer instructions; when the computer instructions are invoked, the method for intelligent control of the gas device disclosed in the first aspect of the present disclosure is performed.

Compared to the prior art, following beneficial effects are provided in the embodiments of the present disclosure.

In embodiments of the present disclosure, provided is a method for intelligent control of a gas device. The method includes: performing an operation pre-process on a gas device to obtain an operation pre-process result corresponding to the gas device after confirming the gas device is powered on, in which the operation pre-process includes device self-testing and control link establishment; performing a temperature measurement to obtain temperature data of a target environment where the gas device is located when the operation pre-process result indicates that the gas device meets preset operating conditions; generating gas control instructions for the gas device according to the temperature data and using requirements for the gas device; and performing an operation adjustment on the gas device according to the gas control instructions, in which the operation adjustment includes at least one of gas flow adjustment, output power adjustment, and gas device on/off control. Evidently, by implementing the present invention, the preset operation pre-process can be automatically performed on the gas device after confirming that the gas device is powered on, so as to achieve device inspection before regular operation of the gas device which includes device self-testing and control link establishment, thereby improving the operational safety of gas devices and the reliability of remote control of control devices. Further, after confirming that the gas device meets operating conditions, the operation adjustment is performed on the gas device based on the collected temperature data of the target environment and the user's demand, so that the operation adjustment of the gas device can meet the user's demand, which is conducive to improving the adaptability of the operation control of the gas device and the user's demand. Also, the operation adjustment of the gas device can also be adapted to the current ambient temperature, so as to appropriately reduce the output power or shut down the gas device when the ambient temperature is too high, and appropriately increase the output power or shut down the gas device when the ambient temperature is too low, which improves the safety and accuracy of the operation adjustment.

### BRIEF DESCRIPTION OF THE DRAWINGS

In order to illustrate the technical solutions of the embodiments of the present disclosure more clearly, the following drawings are briefly described as required in the context of the embodiments. Obviously, the following drawings illustrate only some of the embodiments of the present disclosure. Other relevant drawings may be obtained on the basis of these drawings without any creative effort by those skilled in the art.

FIG. 1 is a schematic flow diagram of a method for intelligent control of a gas device disclosed in an embodiment of the present disclosure;

FIG. 2 is a schematic flow diagram of another method for intelligent control of a gas device disclosed in an embodiment of the present disclosure;

FIG. 3 is a schematic structural diagram of an apparatus for intelligent control of a gas device disclosed in an embodiment of the present disclosure;

FIG. 4 is a schematic structural diagram of another apparatus for intelligent control of a gas device disclosed in an embodiment of the present disclosure;

FIG. 5 is a schematic structural diagram of yet another apparatus for intelligent control of a gas device disclosed in an embodiment of the present disclosure.

### DETAILED DESCRIPTION

For a better understanding of the solutions of the present disclosure by those skilled in the art, the technical solutions in the embodiments of the present disclosure are clearly and completely described and discussed below in conjunction with the attached drawings of the embodiments of the present disclosure. Obviously, the embodiments described herein are only some of the embodiments of the present disclosure but not all of them. Based on the embodiments in the present disclosure, all other embodiments acquired by those skilled in the art without inventive effort fall within the scope of protection of the present disclosure.

The terms “first”, “second”, and the like in the specification, the claims and the above-mentioned drawings of the present disclosure are used to identify different objects and are not intended to describe a particular sequence. Additionally, the terms “comprise” and “include”, and any derivatives and conjugations thereof, are intended to cover non-exclusive inclusion. For example, a process, method, apparatus, product, or device that includes a series of steps or units is not limited to the listed steps or units, but optionally also includes steps or units that are not listed, or optionally also includes other steps or units that are inherent to those processes, methods, products, or devices.

The term “embodiment” herein means that a particular feature, structure or characteristic described in conjunction with an embodiment may be included in at least one embodiment of the present disclosure. The presence of the term in various places in the specification does not necessarily indicate the same embodiment, nor is it a separate or alternative embodiment that is mutually exclusive with other embodiments. It is understood, both explicitly and implicitly, by those skilled in the art that the embodiments described herein may be combined with other embodiments.

Disclosed in the present disclosure is a method and an apparatus for intelligent control of a gas device. The preset operation pre-process can be automatically performed on the gas device after confirming that the gas device is powered on, so as to achieve device inspection before regular operation of the gas device which includes device self-testing and control link establishment, thereby improving the operational safety of gas devices and the reliability of remote control of control devices. Further, after confirming that the gas device meets operating conditions, the operation adjustment is performed on the gas device based on the collected temperature data of the target environment and the user's demand, so that the operation adjustment of the gas device can meet the user's demand, which is conducive to improving the adaptability of the operation control of the gas device and the user's demand. Also, the operation adjustment of the gas device can also be adapted to the current ambient temperature, so as to appropriately reduce the output power or shut down the gas device when the ambient temperature is too high, and appropriately increase the output power or shut down the gas device when the ambient temperature is too low, which improves the safety and accuracy of the operation adjustment. Detailed descriptions are provided respectively as follows.

### Embodiment I

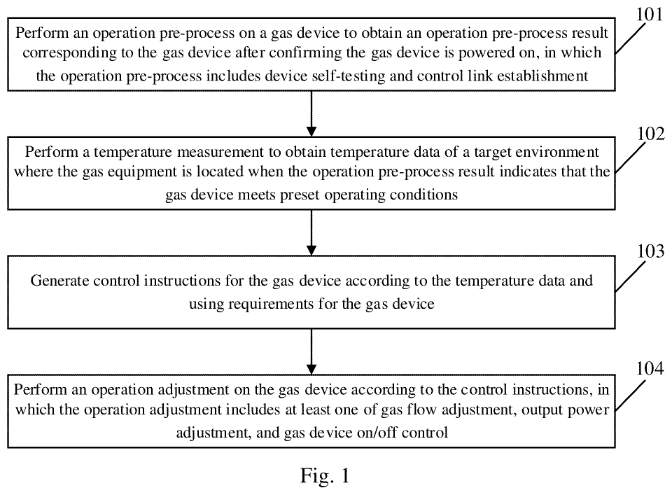

Referring to FIG. 1, FIG. 1 is a schematic flow diagram of a method for intelligent control of a gas device disclosed in an embodiment of the present disclosure. The method for intelligent control of the gas device described in FIG. 1 may be applied to an apparatus for intelligent control of a gas device, which is not limited in the embodiment of the present disclosure. As shown in FIG. 1, the method for intelligent control of the gas device may include following steps:

In step 101, an operation pre-process is performed on a gas device to obtain an operation pre-process result corresponding to the gas device after confirming the gas device is powered on, in which the operation pre-process includes device self-testing and control link establishment.

In the embodiment of the present disclosure, the device self-test includes a module check for each functional module in the gas device, which includes all functional modules including Bluetooth WiFi module, WDT, ROM, RAM, Analog/Digital module and other functions. Further, when a module self-test result of a certain functional module indicating a failure is present, abnormality and alarm information for the functional module is generated correspondingly, and output prompts are provided for the abnormality and alarm information.

In the embodiment of the present disclosure, the control link establishment is as follows: after determining that all functional modules pass the self-test, the control link is established for each control terminal of the gas device, which includes the user's mobile terminal (such as tablet, cell phone, and controller), and the user's terminal (such as a desktop computer, a personal computer, and a control platform). After determining that the control link establishment between the gas device and the at least one control terminal is complete, it is confirmed that the gas device satisfies the preset operating conditions.

In the embodiment of the present disclosure, the operation pre-process result includes at least a self-test result corresponding to a self-test of the device. Optionally, the operation pre-process result further includes a link establishment result corresponding to the control link establishment.

When the self-test result indicates that the self-test for the gas device is passed, and the link establishment result indicates that the control link establishment is completed, and there is no abnormality in the communication of the established control link, it is confirmed that the gas device satisfies the preset operating conditions.

In step 102, a temperature measurement is performed to obtain temperature data of a target environment where the gas device is located when the operation pre-process result indicates that the gas device meets preset operating conditions.

In the embodiment of the present disclosure, the gas device is configured with a temperature detecting circuit/module that is capable of being configured to perform sensing detection of temperature data.

In the embodiment of the present disclosure, the temperature data detected by the temperature detecting circuit/module may be the data obtained after data analysis by the temperature detecting circuit/module itself, or the temperature signal may only be collected, and the temperature detecting circuit/module feeds the temperature signal back to the signal parsing module in the background, through which the signal parsing module parses the temperature signal to obtain the temperature data corresponding to the temperature signal, which is not limited by the embodiments of the present disclosure.

In the embodiment of the present disclosure, the temperature data of the target environment includes at least a temperature value of the target environment, which may be an average temperature value within a preset monitoring period, or a temperature interval. For example, an average temperature value within the time period from 2:00 p.m. to 4:00 p.m., or a temperature interval corresponding to a maximum temperature and a minimum temperature, which is not limited by the embodiments of the present disclosure.

In the embodiment of the present disclosure, optionally, the temperature data of the target environment may also include the temperature change situation of the target environment, such as the temperature rise situation, the rise trend, the temperature rise rate, the temperature fall situation, the fall trend, and the temperature fall rate, which are not limited by the embodiments of the present disclosure.

In step 103, control instructions for the gas device are generated according to the temperature data and using requirements for the gas device.

In the embodiment of the present disclosure, the usage requirement for the gas device may be a demand triggered in real time by the current user for the gas device or a demand determined by the gas device according to the user's preset instructions, i.e., the former corresponds to the real-time usage requirement, and the latter corresponds to the preset programmed usage requirement.

In step 104, an operation adjustment is performed on the gas device according to the control instructions, in which the operation adjustment includes at least one of gas flow adjustment, output power adjustment, and gas device on/off control.

In the embodiment of the present disclosure, the same gas device is correspondingly associated with at least one combustion appliance, e.g., when the gas device is applied to a gas stove application scenario, the combustion appliance may refer to a gas providing appliance for the gas stove. In this case, the operation adjustment includes at least one of the following: (a) an operation adjustment for the gas device; and (b) an operation adjustment for the combustion appliance.

Evidently, by implementing the method for intelligent control of the gas device described in FIG. 1, the preset operation pre-process can be automatically performed on the gas device after confirming that the gas device is powered on, so as to achieve device inspection before regular operation of the gas device which includes device self-testing and control link establishment, thereby improving the operational safety of gas devices and the reliability of remote control of control devices. Further, after confirming that the gas device meets operating conditions, the operation adjustment is performed on the gas device based on the collected temperature data of the target environment and the user's demand, so that the operation adjustment of the gas device can meet the user's demand, which is conducive to improving the adaptability of the operation control of the gas device and the user's demand. Also, the operation adjustment of the gas device can also be adapted to the current ambient temperature, so as to appropriately reduce the output power or shut down the gas device when the ambient temperature is too high, and appropriately increase the output power or shut down the gas device when the ambient temperature is too low, which improves the safety and accuracy of the operation adjustment.

In an optional implementation, the aforementioned step 103 of the control instructions for the gas device being generated according to the temperature data and using requirements for the gas device specifically includes:
comparing the temperature data and a reference temperature range to obtain a comparison result between the temperature data and the reference temperature range, in which the comparison result includes: a first comparison result indicating the temperature data are higher than the reference temperature range, a second comparison result indicating the temperature data are lower than the reference temperature range, or a third comparison result indicating the temperature data are within the reference temperature range; and
generating gas control instructions for the gas device in combination with current device operation parameters of the gas device, using the control specification and the device adjustment requirements included therein as a baseline item, and the comparison result as a corrected reference item.

In this optional implementation, the method further includes:
calculating a temperature difference between the temperature data and the reference temperature interval when the comparison result is the first comparison result or the second comparison result;
calculating, according to a preset temperature and heat loss formula, the heat loss for the temperature difference to obtain a heat loss value corresponding to the temperature difference; and
adding the heat loss value to the comparison result to update the comparison result.

In this optional implementation, on the premise that there is currently no need for power on/off control of the gas device, the output power of the gas device is reduced to a certain extent when the comparison result is the first comparison result, so as to reduce the excess power consumption of the gas device or to prevent the output power of the gas device from remaining unchanged, resulting in subsequent overheating of the gas device. Similarly, the output power of the gas device is increased to a certain extent when the comparison result is the second comparison result. The temperature data being lower than the reference temperature range indicates that the current temperature data can cause heat loss for the operation of the gas device. If the gas device does not carry out a correction of the operating parameters, the gas device is unable to accurately adapt to the current usage requirement. For example, if an ingredient A is scheduled to take half an hour to cook, in the case of heat loss (or even significant heat loss), the time taken to cook ingredient A may be extended to 45 minutes or even an hour, which may require adjustments to the current operating parameters of the gas device.

Evidently, in this optional implementation, a gas control instruction correction and generation method based on different comparison results between temperature data and the reference temperature range is set up to achieve accurate generating of gas control instructions by combining the different comparison results between temperature data and the reference temperature range with the control specification, device adjustment requirements and current device operation parameters, which improves the accuracy and reliability of generating gas control instructions.

In another optional implementation, the step 104 of performing, according to the control instructions, the operation adjustment on the gas device specifically includes:
identifying instruction execution items corresponding to the control instructions;
traversing a target operation program matching the instruction execution items among the operation programs configured in the gas device;
identifying, according to the instruction execution items, program execution parameters of the target operation program, in which the program execution parameters include at least one parameter of: a first parameter configured to perform gas flow adjustment, a second parameter configured to perform output power adjustment, and a third parameter configured to perform gas device on/off control; and
performing, according to the target operation program and the program execution parameters corresponding thereto, the operation adjustment on the gas device.

Evidently, in this optional implementation, after receiving the gas control instruction, the gas device can automatically traverse the matching target operation program among the operation programs, identify the program execution parameters matching the instruction execution items, take the target operation program as the overall level, combined with the specific program execution parameters as the subdivided level, achieving the operation adjustment of the gas device, and improving the fineness of the gas device's execution and adjustment of the gas control instruction.

### Embodiment 2

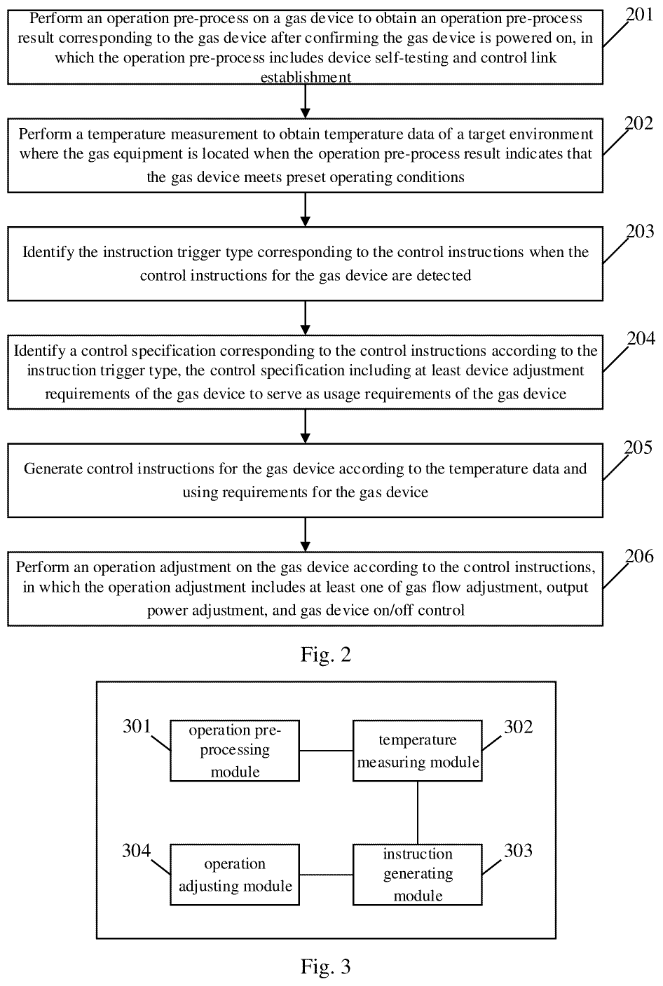

Referring to FIG. 2, FIG. 2 is a schematic flow diagram of another method for intelligent control of a gas device disclosed in an embodiment of the present disclosure. The method for intelligent control of the gas device described in FIG. 2 may be applied to an apparatus for intelligent control of a gas device, which is not limited in the embodiment of the present disclosure. As shown in FIG. 2, the method for intelligent control of the gas device may include following steps:

In step 201, an operation pre-process is performed on a gas device to obtain an operation pre-process result corresponding to the gas device after confirming the gas device is powered on, in which the operation pre-process includes device self-testing and control link establishment.

In step 202, a temperature measurement is performed to obtain temperature data of a target environment where the gas device is located when the operation pre-process result indicates that the gas device meets preset operating conditions.

In step 203, the instruction trigger type is identified corresponding to the control instructions when the control instructions for the gas device are detected.

In some embodiments, the instruction trigger type includes a real-time trigger type or a non-real-time trigger type. The control instructions are generated when one of preset conditions is met if the instruction trigger type is the non-real-time trigger type.

In the embodiment of the present disclosure, if the instruction trigger type is a real-time trigger type, the control instruction may be generated after the user triggers a key on the gas device, or may be an instruction issued by the user to the gas device through a remote control device, which includes the user's mobile terminal (such as a mobile phone, a tablet, and a remote control), a fixed terminal (such as a PC, a desktop computer, and a platform), and the like.

In step 204, a control specification is identified corresponding to the control instructions according to the instruction trigger type, the control specification including at least device adjustment requirements of the gas device to serve as usage requirements of the gas device.

In some embodiments, the control specification includes at least an operating duration control specification of the gas device and an output power adjustment specification corresponding thereto.

In the embodiment of the present disclosure, further, the output power adjustment specification includes a power adjustment type and the to-be-adjusted value corresponding thereto, and the power adjustment type includes a power-tuned-up type or a power-tuned-down type.

In the embodiment of the present disclosure, the operation duration control specification includes different duration control types, and the duration control type includes a continuous control type or an intermittent control type. The output power adjustment specification corresponding to the operation duration control specification includes only one to-be-adjusted value of the output power when the duration control type is a continuous control type, and the to-be-adjusted value corresponding to the output power adjustment specification corresponding to the operation duration control specification is greater than one when the duration control type is an intermittent control type. That is, when the duration control specification is an intermittent control type, the different to-be-adjusted values correspond to value maintaining durations that match the to-be-adjusted values.

In step 205, control instructions for the gas device are generated according to the temperature data and using requirements for the gas device.

In step 206, an operation adjustment is performed on the gas device according to the control instructions, in which the operation adjustment includes at least one of gas flow adjustment, output power adjustment, and gas device on/off control.

In the present embodiment of the disclosure, for other descriptions of step 201 to step 202 and step 205 to step 206, please refer to the other detailed descriptions of step 101 to step 102 and step 103 to step 104 in Embodiment I, which are not repeated in the present embodiment of the disclosure.

Evidently, by implementing the method for intelligent control of the gas device described in FIG. 2, after the control instructions are detected, the instruction trigger type and the control specification corresponding thereto can be identified as the subsequent usage requirements for controlling the gas device, which improves the accuracy of identifying the usage requirements and facilitates the subsequent accurate control of the gas device according to the usage requirements in terms of the instruction trigger type and the control specification, which is conducive to improving the convenience and accuracy of the subsequent implementation of the control of the gas device.

In an optional implementation, the aforementioned step 204 of a control specification being identified corresponding to the control instructions according to the instruction trigger type specifically includes:
identifying, from a gas control program corresponding to the gas devices, an adaptation response program corresponding to the control instructions and an adaptation program function corresponding to the control instructions to serve as the control specification corresponding to the control instructions if the instruction trigger type is the real-time trigger type;
obtaining device historical use data of the gas device if the instruction trigger type is the non-real-time trigger type;
   identifying, from the device historical use data, target use data matching current use conditions; and
identifying, from the target use data, operation data corresponding to historical post-operation of the current use conditions to serve as the control specification corresponding to the control instructions, the operation data being operation log data of the gas device.

Evidently, in this optional implementation, in response to different instruction trigger types, different control specifications are set up to determine the process, which improves the accuracy and reliability of determining the control specifications. Also, the response settings in response to different instruction trigger types allow the control of gas devices to be adapted to the diversified usage requirements of users, which is conducive to the broadening of the application scenarios of gas devices, and improves the applicability of gas devices and the convenience of their use by the users.

In this optional implementation, further, the step of identifying, from the device historical use data, target use data matching current use conditions specifically includes:
identifying time information and device operation information corresponding to the gas device currently in use, in which the time information includes at least start-up time of the gas device, and the device operation information include at least current operation parameters of the gas device;
performing a data match on the device historical use data using the time information, the device operation information, and the temperature data as basis parameters to obtain a data match result, the data match result including at least one piece of the device historical use data to be filtered and being marked as candidate data, in which a matching priority of the device operation information and the temperature data is higher than that of the time information;
determining whether target candidate data are present in all the candidate data; and
   identifying the target candidate data as the target use data matching the current use conditions when it is determined that the target candidate data are present in all the candidate data, in which a data matching value of the target candidate data is higher than a preset matching threshold value.

Evidently, in this optional implementation, in response to the case that the instruction trigger type is a non-real-time trigger type, a multi-dimensional information matching and determination method based on the time information, device operation information and temperature data of the gas device currently in use is set up when the target use data of the current use conditions are determined, which is conducive to improving the filtering finesse of matching the target data obtained from the historical use data of the device as well as improving the accuracy of the data matching results obtained.

In this optional implementation, each piece of the candidate data includes a first matching value corresponding to the time information, a second matching value corresponding to the device operation information, and a third matching value corresponding to the temperature information.

Optionally, the step of identifying, from the device historical use data, target use data matching current use conditions further includes:
identifying, from all the candidate data, secondary preferred data when it is determined, from all the candidate data, that none of the target candidate data is higher than the preset matching threshold value, in which the secondary preferred data are data among all the candidate data meet at least one of following conditions: the first match value corresponding to the candidate data is a highest one, the second match value corresponding to the candidate data is a highest one, and the third match value corresponding to the candidate data is a highest one, and an amount of the secondary preferred data is within a preset number range; and
performing a parameter integration of all the secondary preferred data using the time information, the device operation information, and the temperature data as integration terms, to obtain parameter integration data to serve as the target use data matching the current use conditions.

Evidently, in this optional implementation, after filtering and obtaining multiple pieces of candidate data, a data filtering and judgment mechanism is further set up for all the candidate data, with a preset matching threshold as the filtering threshold, and the relevant match values corresponding to each piece of candidate data (the first, the second, and the third match values) are filtered. Also, in the case that none of the target candidate data is available for all of the candidate data, it is possible to carry out filtering and identifying of the secondary preferred data, data integration based on the secondary preferred data, and parameter integration, so that the parameter integration data can be identified in real time as the target use data, which expands the means of identifying the target use data and improves the accuracy of identifying the target use data.

### Embodiment 3

Referring to FIG. 3, FIG. 3 is a schematic structural diagram of an apparatus for intelligent control of a gas device disclosed in an embodiment of the present disclosure. The apparatus for intelligent control of the gas device may be a terminal, a device, a system, or a server for intelligent control of the gas device. The server may be a local server, a remote server, or a cloud server. When the server is a non-cloud server, the non-cloud server is able to in communicating connection with the cloud server, which is not limited in the embodiment of the present disclosure. As shown in FIG. 3, the apparatus for intelligent control of gas appliances may include an operation pre-processing module 301, a temperature measuring module 302, an instruction generating module 303, and an operation adjusting module 304.

The operation pre-processing module 301 is configured to perform an operation pre-process on a gas device to obtain an operation pre-process result corresponding to the gas device after confirming the gas device is powered on. The operation pre-process includes device self-testing and control link establishment.

The temperature measuring module 302 is configured to perform a temperature measurement to obtain temperature data of a target environment where the gas device is located when the operation pre-process result indicates that the gas device meets preset operating conditions.

The instruction generating module 303 is configured to generate, according to the temperature data and using requirements for the gas device, control instructions for the gas device.

The operation adjusting module 304 is configured to perform, according to the control instructions, an operation adjustment on the gas device. The operation adjustment includes at least one of gas flow adjustment, output power adjustment, and gas device on/off control.

Evidently, by implementing the apparatus for intelligent control of gas appliances described in FIG. 3, the preset operation pre-process can be automatically performed on the gas device after confirming that the gas device is powered on, so as to achieve device inspection before regular operation of the gas device which includes device self-testing and control link establishment, thereby improving the operational safety of gas devices and the reliability of remote control of control devices. Further, after confirming that the gas device meets operating conditions, the operation adjustment is performed on the gas device based on the collected temperature data of the target environment and the user's demand, so that the operation adjustment of the gas device can meet the user's demand, which is conducive to improving the adaptability of the operation control of the gas device and the user's demand. Also, the operation adjustment of the gas device can also be adapted to the current ambient temperature, so as to appropriately reduce the output power or shut down the gas device when the ambient temperature is too high, and appropriately increase the output power or shut down the gas device when the ambient temperature is too low, which improves the safety and accuracy of the operation adjustment.

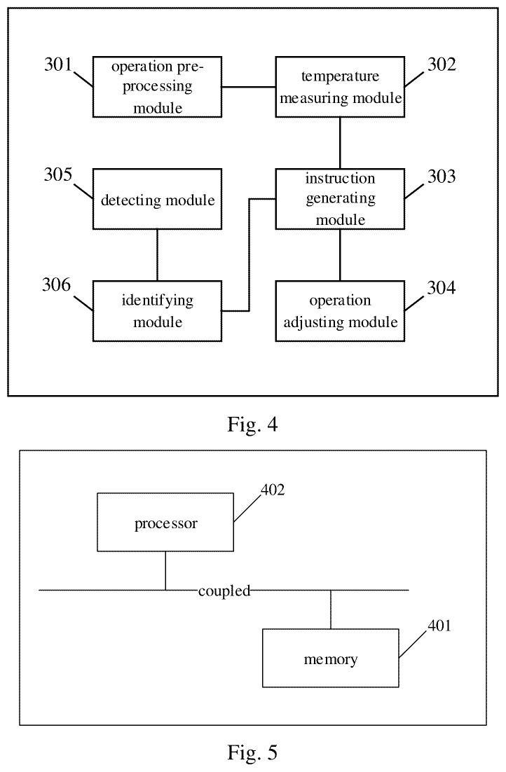

In an optional implementation, as shown in FIG. 4, the apparatus further includes a detecting module 305 and an identifying module 306.

The detecting module 305 is configured to detect the control instructions for the gas device before the instruction generating module 303 generates, according to the temperature data and using requirements for the gas device, the control instructions for the gas device.

The identifying module 306 is configured to identify the instruction trigger type corresponding to the control instructions, the instruction trigger type including a real-time trigger type or a non-real-time trigger type, and to generate the control instructions when one of preset conditions is met if the instruction trigger type is the non-real-time trigger type; and
the identifying module 306 is further configured to identify, according to the instruction trigger type, a control specification corresponding to the control instructions, the control specification including at least device adjustment requirements of the gas device to serve as usage requirements of the gas device,
in which the control specification includes at least an operating duration control specification of the gas device and an output power adjustment specification corresponding thereto.

Evidently, in this optional implementation, after the control instructions are detected, the instruction trigger type and the control specification corresponding thereto can be identified as the subsequent usage requirements for controlling the gas device, which improves the accuracy of identifying the usage requirements and facilitates the subsequent accurate control of the gas device according to the usage requirements in terms of the instruction trigger type and the control specification, which is conducive to improving the convenience and accuracy of the subsequent implementation of the control of the gas device.

In another optional implementation, the way of the identifying module 306 identifying, according to the instruction trigger type, the control specification corresponding to the control instructions specifically includes:
identifying, from a gas control program corresponding to the gas devices, an adaptation response program corresponding to the control instructions and an adaptation program function corresponding to the control instructions to serve as the control specification corresponding to the control instructions if the instruction trigger type is the real-time trigger type;
obtaining device historical use data of the gas device if the instruction trigger type is the non-real-time trigger type;
   identifying, from the device historical use data, target use data matching current use conditions; and
identifying, from the target use data, operation data corresponding to historical post-operation of the current use conditions to serve as the control specification corresponding to the control instructions, the operation data being operation log data of the gas device.

Evidently, in this optional implementation, in response to different instruction trigger types, different control specifications are set up to determine the process, which improves the accuracy and reliability of determining the control specifications. Also, the response settings in response to different instruction trigger types allow the control of gas devices to be adapted to the diversified usage requirements of users, which is conducive to the broadening of the application scenarios of gas devices, and improves the applicability of gas devices and the convenience of their use by the users.

In yet another optional implementation, the way of the identifying module 306 identifying, from the device historical use data, target use data matching current use conditions specifically includes:
identifying time information and device operation information corresponding to the gas device currently in use, in which the time information includes at least start-up time of the gas device, and the device operation information include at least current operation parameters of the gas device;
performing a data match on the device historical use data using the time information, the device operation information, and the temperature data as basis parameters to obtain a data match result, the data match result including at least one piece of the device historical use data to be filtered and being marked as candidate data, in which a matching priority of the device operation information and the temperature data is higher than that of the time information;
determining whether target candidate data are present in all the candidate data; and
   identifying the target candidate data as the target use data matching the current use conditions when it is determined that the target candidate data are present in all the candidate data, in which a data matching value of the target candidate data is higher than a preset matching threshold value.

Evidently, in this optional implementation, in response to the case that the instruction trigger type is a non-real-time trigger type, a multi-dimensional information matching and determination method based on the time information, device operation information and temperature data of the gas device currently in use is set up when the target use data of the current use conditions are determined, which is conducive to improving the filtering finesse of matching the target data obtained from the historical use data of the device as well as improving the accuracy of the data matching results obtained.

In this optional implementation, each piece of the candidate data includes a first matching value corresponding to the time information, a second matching value corresponding to the device operation information, and a third matching value corresponding to the temperature information.

Optionally, the way of the identifying module 306 identifying, from the device historical use data, target use data matching current use conditions specifically further includes:
identifying, from all the candidate data, secondary preferred data when it is determined, from all the candidate data, that none of the target candidate data is higher than the preset matching threshold value, in which the secondary preferred data are data among all the candidate data meet at least one of following conditions: the first match value corresponding to the candidate data is a highest one, the second match value corresponding to the candidate data is a highest one, and the third match value corresponding to the candidate data is a highest one, and an amount of the secondary preferred data is within a preset number range; and
performing a parameter integration of all the secondary preferred data using the time information, the device operation information, and the temperature data as integration terms, to obtain parameter integration data to serve as the target use data matching the current use conditions.

Evidently, in this optional implementation, after filtering and obtaining multiple pieces of candidate data, a data filtering and judgment mechanism is further set up for all the candidate data, with a preset matching threshold as the filtering threshold, and the relevant match values corresponding to each piece of candidate data (the first, the second, and the third match values) are filtered. Also, in the case that none of the target candidate data is available for all of the candidate data, it is possible to carry out filtering and identifying of the secondary preferred data, data integration based on the secondary preferred data, and parameter integration, so that the parameter integration data can be identified in real time as the target use data, which expands the means of identifying the target use data and improves the accuracy of identifying the target use data.

In another optional implementation, the way of the instruction generating module 303 generating, according to the temperature data and using requirements for the gas device, control instructions for the gas device specifically includes:
comparing the temperature data and a reference temperature range to obtain a comparison result between the temperature data and the reference temperature range, in which the comparison result includes: a first comparison result indicating the temperature data are higher than the reference temperature range, a second comparison result indicating the temperature data are lower than the reference temperature range, or a third comparison result indicating the temperature data are within the reference temperature range; and
generating gas control instructions for the gas device in combination with current device operation parameters of the gas device, using the control specification and the device adjustment requirements included therein as a baseline item, and the comparison result as a corrected reference item.

In this optional implementation, a gas control instruction correction and generation method based on different comparison results between temperature data and the reference temperature range is set up to achieve accurate generating of gas control instructions by combining the different comparison results between temperature data and the reference temperature range with the control specification, device adjustment requirements and current device operation parameters, which improves the accuracy and reliability of generating gas control instructions.

In this optional implementation, the way of the operation adjusting module 304 performing, according to the control instructions, an operation adjustment on the gas device specifically includes:
identifying instruction execution items corresponding to the control instructions;
traversing a target operation program matching the instruction execution items among the operation programs configured in the gas device;
identifying, according to the instruction execution items, program execution parameters of the target operation program, in which the program execution parameters include at least one parameter of: a first parameter configured to perform gas flow adjustment, a second parameter configured to perform output power adjustment, and a third parameter configured to perform gas device on/off control; and
performing, according to the target operation program and the program execution parameters corresponding thereto, the operation adjustment on the gas device.

Evidently, in this optional implementation, after receiving the gas control instruction, the gas device can automatically traverse the matching target operation program among the operation programs, identify the program execution parameters matching the instruction execution items, take the target operation program as the overall level, combined with the specific program execution parameters as the subdivided level, achieving the operation adjustment of the gas device, and improving the fineness of the gas device's execution and adjustment of the gas control instruction.

### Embodiment IV

Referring to FIG. 5, FIG. 5 is a schematic structural diagram of another apparatus for intelligent control of a gas device disclosed in an embodiment of the present disclosure. As shown in FIG. 5, the apparatus for intelligent control of the gas device may include:
a memory 401, memorized with an executable code; and
a processor 402, coupled with the memory 401.

The processor 402 invokes the executable code memorized in the memory 401 to perform steps of the method for intelligent control of the gas device as described in embodiment I or embodiment II.

### Embodiment V

Disclosed in the present embodiment of the disclosure is a non-transitory computer memory medium, the non-transitory computer memory medium memorizes computer instructions; the computer instructions, when invoked, are configured to cause steps of the method for intelligent control of the gas device described in the embodiment I and embodiment II of the present disclosure to be performed.

### Embodiment VI

Disclosed in the present embodiment of the disclosure is a computer program product, the computer program product including a non-transitory computer memory medium memorized with a computer program. The computer program may be operated to enable the computer to perform steps in the method for intelligent control of the gas device described in the embodiment I or embodiment II.

The aforementioned described embodiment of the apparatus is only illustrative. The modules described as separate components may or may not be physically separated, and the modules used as components for display may or may not be physical modules, that is, they may be located in the same place or may be distributed to a plurality of network modules. Some or all these modules may be selected according to practical demands to achieve the purpose of the solution of the present embodiment. It may be understood and performed by a person of ordinary skill in the art without inventive effort.

With the specific description of the above embodiments, it is clear to those skilled in the art that the various implementations may be implemented with the aid of software plus the necessary common hardware platform, and admittedly, with the aid of hardware. Based on such an understanding, the above technical solutions that essentially or contribute to the prior art may be embodied in the form of a software product which may be memorized in a non-transitory computer memory medium, the non-transitory memory medium including Read-Only Memory, Random Access Memory, Programmable Read-only Memory, Erasable Programmable Read Only Memory, One-time Programmable Read-Only Memory, Electrically-Erasable Programmable Read-Only Memory, Compact Disc Read-Only Memory, other Compact Disc Memory, Disk Memory, Tape Memory or any other non-transitory computer-readable medium that may be used to carry or memorize data.

Finally, it should be noted that the method and apparatus for intelligent control of the gas device, and non-transitory computer memory medium disclosed in the embodiments of the present disclosure are only preferred embodiments of the present disclosure, and are only used to illustrate the technical solutions of the present disclosure, but not to limit them. Despite the detailed description of the disclosure with reference to the aforementioned embodiments, it should be understood, by those skilled in the art, that the technical solutions recorded in the aforementioned embodiments may still be modified, or equivalent substitutions for some of the technical features thereof may be made, but the essence of the corresponding technical solutions of these modifications or substitutions is without departing from the spirit and scope of the technical solutions of the various embodiments of the disclosure.

1. A method for intelligent control of a gas device, comprising:
performing an operation pre-process on a gas device to obtain an operation pre-process result corresponding to the gas device after confirming the gas device is powered on, wherein the operation pre-process comprises device self-testing and control link establishment;
performing a temperature measurement to obtain temperature data of a target environment where the gas device is located when the operation pre-process result indicates that the gas device meets preset operating conditions;
generating, according to the temperature data and using requirements for the gas device, control instructions for the gas device; and
performing, according to the control instructions, an operation adjustment on the gas device, wherein the operation adjustment comprises at least one of gas flow adjustment, output power adjustment, and gas device on/off control.

2. The method for intelligent control of the gas device according to claim 1, wherein, before the generating, according to the temperature data and using requirements for the gas device, control instructions to the gas device, the method further comprises:
identifying an instruction trigger type corresponding to the control instructions if the control instructions for the gas device are detected, the instruction trigger type comprising a real-time trigger type or a non-real-time trigger type; generating the control instructions when one of preset conditions is met if the instruction trigger type is the non-real-time trigger type; and
identifying, according to the instruction trigger type, a control specification corresponding to the control instructions, the control specification comprising at least device adjustment requirements of the gas device to serve as usage requirements of the gas device,
wherein the control specification further comprises at least an operating duration control specification of the gas device and an output power adjustment specification corresponding thereto.

3. The method for intelligent control of the gas device according to claim 2, wherein the identifying, according to the instruction trigger type, the control specification corresponding to the control instructions comprises:
identifying, from a gas control program corresponding to the gas devices, an adaptation response program corresponding to the control instructions and an adaptation program function corresponding to the control instructions to serve as the control specification corresponding to the control instructions if the instruction trigger type is the real-time trigger type;
obtaining device historical use data of the gas device if the instruction trigger type is the non-real-time trigger type;
identifying, from the device historical use data, target use data matching current use conditions; and
identifying, from the target use data, operation data corresponding to historical post-operation of the current use conditions to serve as the control specification corresponding to the control instructions, the operation data being operation log data of the gas device.

4. The method for intelligent control of the gas device according to claim 3, wherein the identifying, from the device historical use data, target use data matching current use conditions comprises:
identifying time information and device operation information corresponding to the gas device currently in use, wherein the time information comprises at least start-up time of the gas device, and the device operation information comprise at least current operation parameters of the gas device;
performing a data match on the device historical use data using the time information, the device operation information, and the temperature data as basis parameters to obtain a data match result, the data match result comprising at least one piece of the device historical use data to be filtered and being marked as candidate data, wherein a matching priority of the device operation information and the temperature data is higher than that of the time information;
determining whether target candidate data are present in all the candidate data; and
identifying the target candidate data as the target use data matching the current use conditions when it is determined that the target candidate data are present in all the candidate data, wherein a data matching value of the target candidate data is higher than a preset matching threshold value.

5. The method for intelligent control of the gas device according to claim 4, wherein each piece of the candidate data comprises a first matching value corresponding to the time information, a second matching value corresponding to the device operation information, and a third matching value corresponding to the temperature information;
the identifying, from the device historical use data, target use data matching current use conditions further comprises:
identifying, from all the candidate data, secondary preferred data when it is determined, from all the candidate data, that none of the target candidate data is higher than the preset matching threshold value, wherein the secondary preferred data are data among all the candidate data meet at least one of following conditions: the first match value corresponding to the candidate data is a highest one, the second match value corresponding to the candidate data is a highest one, and the third match value corresponding to the candidate data is a highest one, and an amount of the secondary preferred data is within a preset number range; and
performing a parameter integration of all the secondary preferred data using the time information, the device operation information, and the temperature data as integration terms, to obtain parameter integration data to serve as the target use data matching the current use conditions.

6. The method for intelligent control of the gas device according to claim 2, wherein the generating, according to the temperature data and using requirements for the gas device, control instructions for the gas device comprises:
comparing the temperature data and a reference temperature range to obtain a comparison result between the temperature data and the reference temperature range, wherein the comparison result comprises: a first comparison result indicating the temperature data are higher than the reference temperature range, a second comparison result indicating the temperature data are lower than the reference temperature range, or a third comparison result indicating the temperature data are within the reference temperature range; and
generating gas control instructions for the gas device in combination with current device operation parameters of the gas device, using the control specification and the device adjustment requirements included therein as a baseline item, and the comparison result as a corrected reference item.

7. The method for intelligent control of the gas device according to claim 3, wherein the generating, according to the temperature data and using requirements for the gas device, control instructions for the gas device comprises:
comparing the temperature data and a reference temperature range to obtain a comparison result between the temperature data and the reference temperature range, wherein the comparison result comprises: a first comparison result indicating the temperature data are higher than the reference temperature range, a second comparison result indicating the temperature data are lower than the reference temperature range, or a third comparison result indicating the temperature data are within the reference temperature range; and
generating gas control instructions for the gas device in combination with current device operation parameters of the gas device, using the control specification and the device adjustment requirements included therein as a baseline item, and the comparison result as a corrected reference item.

8. The method for intelligent control of the gas device according to claim 4, wherein the generating, according to the temperature data and using requirements for the gas device, control instructions for the gas device comprises:
comparing the temperature data and a reference temperature range to obtain a comparison result between the temperature data and the reference temperature range, wherein the comparison result comprises: a first comparison result indicating the temperature data are higher than the reference temperature range, a second comparison result indicating the temperature data are lower than the reference temperature range, or a third comparison result indicating the temperature data are within the reference temperature range; and
generating gas control instructions for the gas device in combination with current device operation parameters of the gas device, using the control specification and the device adjustment requirements included therein as a baseline item, and the comparison result as a corrected reference item.

9. The method for intelligent control of the gas device according to claim 5, wherein the generating, according to the temperature data and using requirements for the gas device, control instructions for the gas device comprises:
comparing the temperature data and a reference temperature range to obtain a comparison result between the temperature data and the reference temperature range, wherein the comparison result comprises: a first comparison result indicating the temperature data are higher than the reference temperature range, a second comparison result indicating the temperature data are lower than the reference temperature range, or a third comparison result indicating the temperature data are within the reference temperature range; and
generating gas control instructions for the gas device in combination with current device operation parameters of the gas device, using the control specification and the device adjustment requirements included therein as a baseline item, and the comparison result as a corrected reference item.

10. The method for intelligent control of the gas device according to claim 6, wherein the performing, according to the control instructions, the operation adjustment on the gas device comprises:
identifying instruction execution items corresponding to the control instructions;
traversing a target operation program matching the instruction execution items among the operation programs configured in the gas device;
identifying, according to the instruction execution items, program execution parameters of the target operation program, wherein the program execution parameters comprise at least one parameter of: a first parameter configured to perform gas flow adjustment, a second parameter configured to perform output power adjustment, and a third parameter configured to perform gas device on/off control; and
performing, according to the target operation program and the program execution parameters corresponding thereto, the operation adjustment on the gas device.

11. An apparatus for intelligent control of a gas device, comprising:
a memory, memorized with an executable code; and
a processor, coupled with the memory,
wherein the processor invokes the executable code memorized in the memory to perform a method for intelligent control of a gas device, the method for intelligent control of a gas device comprising:
performing an operation pre-process on a gas device to obtain an operation pre-process result corresponding to the gas device after confirming the gas device is powered on, wherein the operation pre-process comprises device self-testing and control link establishment;
performing a temperature measurement to obtain temperature data of a target environment where the gas device is located when the operation pre-process result indicates that the gas device meets preset operating conditions;
generating, according to the temperature data and using requirements for the gas device, control instructions for the gas device; and
performing, according to the control instructions, an operation adjustment on the gas device, wherein the operation adjustment comprises at least one of gas flow adjustment, output power adjustment, and gas device on/off control.

12. The apparatus for intelligent control of the gas device according to claim 11, wherein, before the generating, according to the temperature data and using requirements for the gas device, control instructions to the gas device, the method further comprises:
identifying an instruction trigger type corresponding to the control instructions if the control instructions for the gas device are detected, the instruction trigger type comprising a real-time trigger type or a non-real-time trigger type; generating the control instructions when one of preset conditions is met if the instruction trigger type is the non-real-time trigger type; and
identifying, according to the instruction trigger type, a control specification corresponding to the control instructions, the control specification comprising at least device adjustment requirements of the gas device to serve as usage requirements of the gas device,
wherein the control specification further comprises at least an operating duration control specification of the gas device and an output power adjustment specification corresponding thereto.

13. The apparatus for intelligent control of the gas device according to claim 12, wherein the identifying, according to the instruction trigger type, the control specification corresponding to the control instructions comprises:
identifying, from a gas control program corresponding to the gas devices, an adaptation response program corresponding to the control instructions and an adaptation program function corresponding to the control instructions to serve as the control specification corresponding to the control instructions if the instruction trigger type is the real-time trigger type;
obtaining device historical use data of the gas device if the instruction trigger type is the non-real-time trigger type;
identifying, from the device historical use data, target use data matching current use conditions; and
identifying, from the target use data, operation data corresponding to historical post-operation of the current use conditions to serve as the control specification corresponding to the control instructions, the operation data being operation log data of the gas device.

14. The apparatus for intelligent control of the gas device according to claim 13, wherein the identifying, from the device historical use data, target use data matching current use conditions comprises:
identifying time information and device operation information corresponding to the gas device currently in use, wherein the time information comprises at least start-up time of the gas device, and the device operation information comprise at least current operation parameters of the gas device;
performing a data match on the device historical use data using the time information, the device operation information, and the temperature data as basis parameters to obtain a data match result, the data match result comprising at least one piece of the device historical use data to be filtered and being marked as candidate data, wherein a matching priority of the device operation information and the temperature data is higher than that of the time information;
determining whether target candidate data are present in all the candidate data; and
identifying the target candidate data as the target use data matching the current use conditions when it is determined that the target candidate data are present in all the candidate data, wherein a data matching value of the target candidate data is higher than a preset matching threshold value.

15. The apparatus for intelligent control of the gas device according to claim 14, wherein each piece of the candidate data comprises a first matching value corresponding to the time information, a second matching value corresponding to the device operation information, and a third matching value corresponding to the temperature information;
the identifying, from the device historical use data, target use data matching current use conditions further comprises:
identifying, from all the candidate data, secondary preferred data when it is determined, from all the candidate data, that none of the target candidate data is higher than the preset matching threshold value, wherein the secondary preferred data are data among all the candidate data meet at least one of following conditions: the first match value corresponding to the candidate data is a highest one, the second match value corresponding to the candidate data is a highest one, and the third match value corresponding to the candidate data is a highest one, and an amount of the secondary preferred data is within a preset number range; and
performing a parameter integration of all the secondary preferred data using the time information, the device operation information, and the temperature data as integration terms, to obtain parameter integration data to serve as the target use data matching the current use conditions.

16. The apparatus for intelligent control of the gas device according to claim 12, wherein the generating, according to the temperature data and using requirements for the gas device, control instructions for the gas device comprises:
comparing the temperature data and a reference temperature range to obtain a comparison result between the temperature data and the reference temperature range, wherein the comparison result comprises: a first comparison result indicating the temperature data are higher than the reference temperature range, a second comparison result indicating the temperature data are lower than the reference temperature range, or a third comparison result indicating the temperature data are within the reference temperature range; and
generating gas control instructions for the gas device in combination with current device operation parameters of the gas device, using the control specification and the device adjustment requirements included therein as a baseline item, and the comparison result as a corrected reference item.

17. The apparatus for intelligent control of the gas device according to claim 13, wherein the generating, according to the temperature data and using requirements for the gas device, control instructions for the gas device comprises:
comparing the temperature data and a reference temperature range to obtain a comparison result between the temperature data and the reference temperature range, wherein the comparison result comprises: a first comparison result indicating the temperature data are higher than the reference temperature range, a second comparison result indicating the temperature data are lower than the reference temperature range, or a third comparison result indicating the temperature data are within the reference temperature range; and
generating gas control instructions for the gas device in combination with current device operation parameters of the gas device, using the control specification and the device adjustment requirements included therein as a baseline item, and the comparison result as a corrected reference item.

18. The apparatus for intelligent control of the gas device according to claim 14, wherein the generating, according to the temperature data and using requirements for the gas device, control instructions for the gas device comprises:
comparing the temperature data and a reference temperature range to obtain a comparison result between the temperature data and the reference temperature range, wherein the comparison result comprises: a first comparison result indicating the temperature data are higher than the reference temperature range, a second comparison result indicating the temperature data are lower than the reference temperature range, or a third comparison result indicating the temperature data are within the reference temperature range; and
generating gas control instructions for the gas device in combination with current device operation parameters of the gas device, using the control specification and the device adjustment requirements included therein as a baseline item, and the comparison result as a corrected reference item.

19. The apparatus for intelligent control of the gas device according to claim 16, wherein the performing, according to the control instructions, the operation adjustment on the gas device comprises:
identifying instruction execution items corresponding to the control instructions;
traversing a target operation program matching the instruction execution items among the operation programs configured in the gas device;
identifying, according to the instruction execution items, program execution parameters of the target operation program, wherein the program execution parameters comprise at least one parameter of: a first parameter configured to perform gas flow adjustment, a second parameter configured to perform output power adjustment, and a third parameter configured to perform gas device on/off control; and
performing, according to the target operation program and the program execution parameters corresponding thereto, the operation adjustment on the gas device.

20. A non-transitory computer memory medium, wherein the non-transitory computer memory medium memorizes computer instructions, and the computer instructions, when invoked, are configured to cause a method for intelligent control of the gas device to be performed;
wherein the method for intelligent control of a gas device comprises:
performing an operation pre-process on a gas device to obtain an operation pre-process result corresponding to the gas device after confirming the gas device is powered on, wherein the operation pre-process comprises device self-testing and control link establishment;
performing a temperature measurement to obtain temperature data of a target environment where the gas device is located when the operation pre-process result indicates that the gas device meets preset operating conditions;
generating, according to the temperature data and using requirements for the gas device, control instructions for the gas device; and
performing, according to the control instructions, an operation adjustment on the gas device, wherein the operation adjustment comprises at least one of gas flow adjustment, output power adjustment, and gas device on/off control.
